(19) United States
(12) Patent Application Publication
(10) Pub. No.: US 2025/0307047 A1
(43) Pub. Date: Oct. 2, 2025

(54) MEMORY WITH ENHANCED FAIL TRACKING, INCLUDING ENHANCED ERROR CHECK AND SCRUB FAIL TRACKING, AND ASSOCIATED SYSTEMS, DEVICES, AND METHODS

(71) Applicant: Micron Technology, Inc., Boise, ID (US)

(72) Inventors: Marina R. Utesheva, Cupertino, CA (US); Rosa M. Avila-Hernandez, Boise, ID (US); Nathaniel J. Meier, Boise, ID (US); Karthika Manilal Pavangat, Tempe, AZ (US); Raksha Gopal Kulkarni, Boise, ID (US); Kathryn Douglass, Idaho Falls, ID (US)

(21) Appl. No.: 19/069,215

(22) Filed: Mar. 3, 2025

Related U.S. Application Data
(60) Provisional application No. 63/570,092, filed on Mar. 26, 2024.

(51) Int. Cl. G06F 11/07

(52) U.S. Cl. CPC G06F 11/076; G06F 11/073

(57) ABSTRACT

Memory with enhanced fail tracking, and associated systems, devices, and methods, are disclosed herein. In one embodiment, a memory device comprises a memory array and fail tracking circuitry. The fail tracking circuitry can include a counter and a plurality of memory slots and can be configured to, for each memory row of a plurality of memory rows in a memory region of the memory array, (a) count errors detected in data read from the memory row to determine an error count, and (b) store the error count and address information for the memory row in a memory slot of the plurality of memory slots. In some embodiments, the fail tracking circuitry can be configured to count the errors and store the error counts during error check and scrub operations of the memory device (e.g., to identify the worst memory rows in the memory region for post-package repair operations).

### CROSS-REFERENCE TO RELATED APPLICATION(S)

The present application claims priority to U.S. Provisional Patent Application No. 63/570,092, filed Mar. 26, 2024, the disclosure of which is incorporated herein by reference in its entirety.

### TECHNICAL FIELD

The present technology is generally related to semiconductor devices. For example, several embodiments of the present technology relate to memory devices that, during error check and scrub (ECS) operations, track and store fail information (e.g., addresses, error counts, and/or types of errors) relating to a plurality of memory rows and that can be used to identify the worst memory rows in a given memory region for post-package repair (PPR) operations.

### BACKGROUND

An electronic apparatus (e.g., a processor, a memory device, a memory system, or a combination thereof) can include one or more semiconductor circuits configured to store and/or process information. For example, the apparatus can include a memory device, such as a volatile memory device, a non-volatile memory device, or a combination device. Memory devices, such as dynamic random-access memory (DRAM) and/or high-bandwidth memory (HBM), can utilize electrical energy to store and access data.

With technological advancements in embedded systems and increasing applications, the market is continuously looking for faster, more efficient, and smaller devices. To meet the market demands, the semiconductor devices are being pushed to the limit with various improvements. Improving devices, generally, may include increasing circuit density, increasing circuit capacity, increasing operating speeds (or otherwise reducing operational latency), increasing reliability, increasing data retention, reducing power consumption, or reducing manufacturing costs, among other metrics. Attempts, however, to meet the market demands, such as by reducing the overall device footprint, can often introduce challenges in other aspects, such as maintaining circuit robustness and/or failure detectability.

### BRIEF DESCRIPTION OF THE DRAWINGS

Many aspects of the present disclosure can be better understood with reference to the following drawings. The components in the drawings are not necessarily to scale. Instead, emphasis is placed on illustrating clearly the principles of the present disclosure. The drawings should not be taken to limit the disclosure to the specific embodiments depicted, but are for explanation and understanding only.

FIG. 1 is a partially schematic cross-sectional side view of a system-in-package device configured in accordance with various embodiments of the present technology.

FIG. 2 is a block diagram schematically illustrating a memory device configured in accordance with various embodiments of the present technology.

FIG. 3 is a block diagram of fail tracking circuitry configured in accordance with various embodiments of the present technology.

FIG. 4 is a flow diagram illustrating a method of tracking errors in data stored to a memory array, in accordance with various embodiments of the present technology.

### DETAILED DESCRIPTION

As discussed in more detail below, the present disclosure is directed memory devices that track and store fail information (e.g., addresses, error counts, and/or types of errors) relating to a plurality of memory rows. For example, several embodiments of the present technology are directed to memory devices that include fail tracking circuitry configured, during ECS operations, to track and log fail information for the worst memory rows in a given memory region. In some embodiments, the fail information can be used to identify the worst memory rows as optimal candidates for post-package repair (PPR) operations.

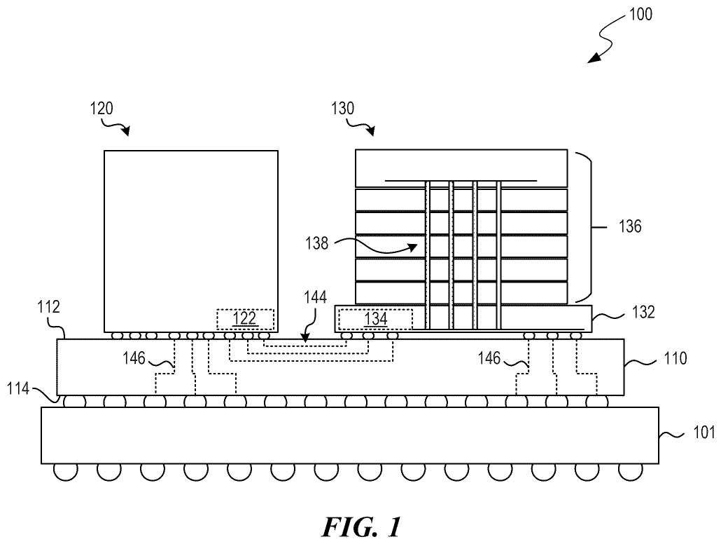

Specific details of several embodiments of the present technology are described herein with reference to FIGS. 1-4. For the sake of clarity and example, the present technology is primarily described below in the context of memory devices incorporating volatile storage elements, such as dynamic random-access memory (DRAM) storage elements. Memory devices configured in accordance with other embodiments of the present technology, however, can include other types of storage elements (e.g., in addition to or in lieu of DRAM storage elements), such as other types of volatile storage elements (e.g., static random-access memory (SRAM) storage elements) and/or non-volatile storage elements (e.g., NAND, NOR, phase change memory (PCM), ferroelectric random-access memory (FeRAM), resistive random-access memory (RRAM), and magnetic random-access memory (MRAM), among others). Moreover, a person of ordinary skill in the art will understand that embodiments of the present technology can have different configurations, components, and/or procedures than those shown or described herein, and/or that these and other embodiments can be without several of the configurations, components, and/or procedures shown or described herein without deviating from the present technology.

Many memory devices include post-package repair (PPR) features that replace defective memory rows with spare or redundant memory rows. For example, when a memory row includes one or more memory cells that repeatedly cause bit errors to occur in data stored to those memory cells, the memory row can be identified as defective (e.g., by the memory device, by a host device, and/or by a user/operator), and an address of the memory row can be remapped to a redundant memory row that includes properly functioning memory cells. Thereafter, when the defective memory row is identified for storing and/or reading out data on the basis of its address, the data can instead be stored to and/or read out from the redundant memory row. For hard PPR (hPPR) operations, the address of the defective memory row is permanently remapped to the redundant memory row. For soft PPR (sPPR) operations, the address of the defective memory row is temporarily remapped to the redundant memory row.

The number of redundant memory rows available for PPR operations is a limited resource. Thus, it can be advantageous to be able to identify the worst memory rows (e.g., memory rows that pose the greatest risk of irrecoverably corrupting data) in a given memory region for PPR operations. For example, it can be advantageous to be able (a) to identify memory rows exhibiting the greatest numbers of errors and/or memory rows exhibiting the most severe types of errors and (b) use the limited number of redundant memory rows to replace those defective memory rows via PPR operations (e.g., rather than using redundant memory rows to replace memory rows that pose a lower risk of irrecoverably corrupting data). In most memory devices, however, tracking of the number of errors detected (sometimes also referred to herein as an “error count”) on a memory row and/or the number of particular types of errors detected, is either not done or is limited.

For example, many memory devices employ error correction code (ECC) functions to correct bit errors in data read out from memory. Error check and scrub (ECS) is a specific example of an ECC function that involves reading data stored to a memory array, checking for errors in the read data using ECC, and writing corrected data back to the memory array in the event errors are detected in the read data. As part of performing the ECS function, a memory device can track (i) a total number of errors (across all accessed memory rows) that were corrected when performing the ECS function and/or (ii) an address corresponding to a memory row with the highest number of errors in a given memory region. But the memory device does not, as part of the ECS function, track (a) the addresses of other memory rows in that memory region that exhibit significant numbers of errors less than the highest number of errors, or (b) the types of errors (e.g., uncorrectable errors, multi-bit correctable errors, single-bit correctable errors) identified and/or corrected in each memory row. As such, aside from identifying a memory row in a given memory region with the absolute highest number of errors, typical ECS functionality of a memory device does not track other information useful for identifying other memory rows in the memory region that are optimal targets for PPR operations.

To address these concerns, several embodiments of the present technology are directed to memory devices that employ fail tracking circuitry to track addresses of a plurality of the worst memory rows in a given memory region. For example, during ECS operations and/or other operations of a memory device, the fail tracking circuitry can count a number of errors (e.g., of any error type or of one or more selected error types) detected in data read out from a memory row. Thereafter, the fail tracking circuitry can compare the detected number of errors to a minimum error count currently stored/logged to memory slots of a fail tracking block of the fail tracking circuitry. In the event the detected number of errors is greater than (or equal to) the minimum error count, the fail tracking circuitry can store/log the detected number of errors and/or address information of the memory row in a memory slot of the fail tracking block (e.g., by replacing or overwriting the minimum error count and/or corresponding address information in the fail tracking block). In the event the detected number of errors is less than (or equal to) the minimum error count, the fail tracking circuitry can, without storing/logging the detected number of errors or address information of the memory row in the fail tracking block, proceed to count a number of errors detected in data read out from another memory row.

The fail tracking block of the fail tracking circuitry can include a plurality of memory slots for storing error counts and address information corresponding to a plurality of memory rows, and can therefore store error counts (e.g., of selected error types) and address information for poor/defective memory rows beyond just the absolute worst memory row in a memory region. As such, after error counts and/or corresponding address information have been stored/logged to the memory slots of the fail tracking block, the error counts and/or the corresponding address information can be read out of the fail tracking block and/or used to identify several of the worst memory rows in a memory region for PPR or other operations. In other words, the present technology provides enhanced error tracking (e.g., during ECS or other operations) that facilitates (e.g., a user/operator and/or a host device) making more intelligent memory repair/retire (e.g., PPR) decisions in comparison to conventional approaches.

FIG. 1 is a partially schematic cross-sectional side view of a system-in-package (SiP) device 100 configured in accordance with various embodiments of the present technology. As shown, the SiP device 100 can include an interposer 110 (or another suitable base substrate) that is carried by a package substrate 101. The SiP device 100 further includes a host device 120 (e.g., a GPU, CPU, TPU, and/or any other suitable processing unit) and a high-bandwidth memory (HBM) device 130 (e.g., an HBM cube). The host device 120 and the HBM device 130 are carried by and electrically coupled to (e.g., integrated with) an upper surface 112 of the interposer 110.

The HBM device 130 includes an interface die 132 (e.g., a base die, a logic die), one or more memory dies 136 carried by the interface die 132, and one or more through substrate vias 138 (“TSVs 138”) coupled to the interface die 132 and each of the memory dies 136. The one or more memory dies 136 can include DRAM dies and/or one or more other types of memory dies. The TSVs 138 allow each of the memory dies 136 in the HBM device 130 to communicate data (e.g., between the memory dies 136 and the interface die 132) at a high rate.

The interface die 132 can communicate data to the host device 120. For example, a physical layer 122 in the host device 120 can be coupled to one or more route lines 144 formed in the interposer 110. In turn, the route lines 144 can be coupled to a physical layer 134 in the HBM device 130. Thus, the interface die 132 in the HBM device 130 can be communicably coupled to the host device 120 via the route lines 144. Similar to the TSVs 138, the route lines 144 can provide a high-bandwidth channel through the interposer 110. Therefore, the HBM device 130 can expand an amount of memory that is accessible to the host device 120 via a high-bandwidth communication channel. Although shown with a single HBM device 130 in FIG. 1, the SiP 100 can include a plurality of HBM devices 130 (e.g., each communicatively coupled to the host device 120 via respective route lines 144) in other embodiments of the present technology.

As illustrated in FIG. 1, the interposer 110 can further include one or more interposer TSVs 146 extending between the upper surface 112 of the interposer 110 and a lower surface 114 of the interposer 110. The interposer TSVs 146 can allow the host device 120 and/or the HBM device 130 to send and/or receive signals (e.g., control signals, instructions, processing results, data, and/or the like) to and/or from, respectively, other devices coupled to the package substrate 101. In a specific, non-limiting example, the interposer TSVs 146 can allow the HBM device 130 to receive data from an external storage device (e.g., a NAND device) coupled to the package substrate 101.

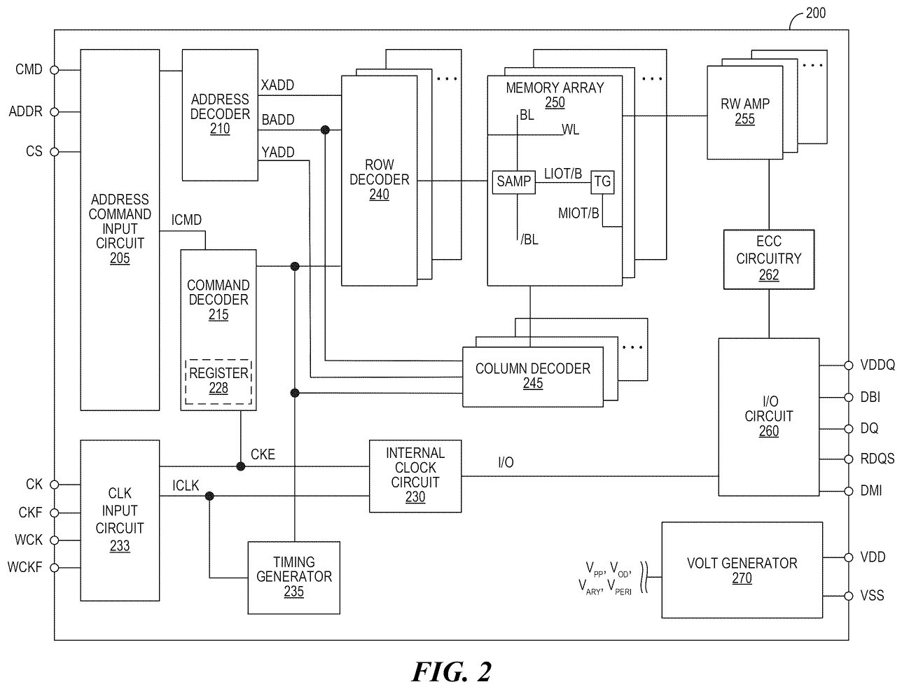

FIG. 2 is a block diagram schematically illustrating a memory device 200 configured in accordance with various embodiments of the present technology. The memory device 200 can be the HBM device 130 of FIG. 1, an individual memory die 136 of the HBM device 130, multiple memory dies 136 of the HBM device 130, the interface die 132 of the HBM device 130, a combination of the interface die 132 and one or more of the memory dies 136 of the HBM device 130, and/or another memory device of the present technology. As shown, the memory device 200 includes an array of memory cells, such as memory array 250. The memory array 250 may include a plurality of banks (e.g., banks 0-15 in the example of FIG. 2), and each bank may include a plurality of word lines (WL), a plurality of bit lines (BL), and a plurality of memory cells (e.g., m×n memory cells) arranged at intersections of the word lines (e.g., m word lines, which may also be referred to as rows) and the bit lines (e.g., n bit lines, which may also be referred to as columns). Each word line of the plurality may be coupled with a corresponding word line driver (WL driver) configured to control a voltage of the word line during memory operations.

Memory cells can include any one of a number of different memory media types, including capacitive, phase change, magnetoresistive, ferroelectric, or the like. In some embodiments, a portion of the memory array 250 may be configured to store ECC information, such as ECC parity bits (ECC check bits) or codes. The selection of a word line WL may be performed by a row decoder 240, and the selection of a bit line BL may be performed by a column decoder 245. Sense amplifiers (SAMP) may be provided for corresponding bit lines BL and connected to at least one respective local I/O line pair (LIOT/B), which may in turn be coupled to at least one respective main I/O line pair (MIOT/B), via transfer gates (TG), which can function as switches. The memory array 250 may also include plate lines and corresponding circuitry for managing their operation.

The memory device 200 may employ a plurality of external terminals that include command and address terminals coupled to a command bus and an address bus to receive command signals CMD and address signals ADDR, respectively. The memory device may further include a chip select terminal to receive a chip select signal CS, clock terminals to receive clock signals CK and CKF, data clock terminals to receive data clock signals WCK and WCKF, data terminals DQ, RDQS, DBI (for data bus inversion function), and DMI (for data mask inversion function), power supply terminals VDD, VSS, and VDDQ.

The power supply terminals may be supplied with power supply potentials VDD and VSS. These power supply potentials VDD and VSS can be supplied to an internal voltage generator circuit 270. The internal voltage generator circuit 270 can generate various internal potentials VPP, VOD, VARY, VPERI, and the like based on the power supply potentials VDD and VSS. The internal potential VPP can be used in the row decoder 240, the internal potentials VOD and VARY can be used in the sense amplifiers included in the memory array 250, and the internal potential VPERI can be used in many other circuit blocks.

The power supply terminals may also be supplied with power supply potential VDDQ. The power supply potential VDDQ can be supplied to the input/output circuit 260 together with the power supply potential VSS. The power supply potential VDDQ can be the same potential as the power supply potential VDD in some embodiments of the present technology. The power supply potential VDDQ can be a different potential from the power supply potential VDD in other embodiments of the present technology. The dedicated power supply potential VDDQ can be used for the input/output circuit 260 so that power supply noise generated by the input/output circuit 260 does not propagate to the other circuit blocks.

The clock terminals and data clock terminals may be supplied with external clock signals and complementary external clock signals. The external clock signals CK, CKF, WCK, WCKF can be supplied to a clock input circuit 233. The CK and CKF signals can be complementary, and the WCK and WCKF signals can also be complementary. Complementary clock signals can have opposite clock levels and transition between the opposite clock levels at the same time. For example, when a clock signal is at a low clock level a complementary clock signal is at a high level, and when the clock signal is at a high clock level the complementary clock signal is at a low clock level. Moreover, when the clock signal transitions from the low clock level to the high clock level the complementary clock signal transitions from the high clock level to the low clock level, and when the clock signal transitions from the high clock level to the low clock level the complementary clock signal transitions from the low clock level to the high clock level.

Input buffers included in the clock input circuit 233 can receive the external clock signals. For example, when enabled by a CKE signal from the command decoder 215, an input buffer can receive the CK and CKF signals and the WCK and WCKF signals. The clock input circuit 233 can receive the external clock signals to generate internal clock signals ICLK. The internal clock signals ICLK can be supplied to an internal clock circuit 230. The internal clock circuit 230 can provide various phase and frequency controlled internal clock signals based on the received internal clock signals ICLK and a clock enable signal CKE from the command decoder 215.

For example, the internal clock circuit 230 can include a clock path (not shown) that receives the internal clock signal ICLK and provides various clock signals to the command decoder 215. The internal clock circuit 230 can further provide input/output (I/O) clock signals. The I/O clock signals can be supplied to an input/output circuit 260 and can be used as a timing signal for determining an output timing of read data and the input timing of write data. The I/O clock signals can be provided at multiple clock frequencies so that data can be output from and input to the memory device 200 at different data rates. A higher clock frequency may be desirable when high memory speed is desired. A lower clock frequency may be desirable when lower power consumption is desired. The internal clock signals ICLK can also be supplied to a timing generator 235 and thus various internal clock signals can be generated.

The command terminals and address terminals may be supplied with an address signal and a bank address signal from outside the memory device 200. The address signal and the bank address signal supplied to the address terminals can be transferred, via a command/address input circuit 205, to an address decoder 210. The address decoder 210 can receive the address signals and supply a decoded row address signal (XADD) to the row decoder 240 (which may be referred to as a row driver), and a decoded column address signal (YADD) to the column decoder 245 (which may be referred to as a column driver). The address decoder 210 can also receive the bank address portion of the ADDR input and supply the decoded bank address signal (BADD) and supply the bank address signal to both the row decoder 240 and the column decoder 245.

The command and address terminals may be supplied with command signals CMD, address signals ADDR, and chip select signals CS, from a memory controller. The command signals may represent various memory commands from the memory controller (e.g., refresh commands, activate commands, precharge commands, access commands, which can include read commands and write commands). The select signal CS may be used to select the memory device 200 to respond to commands and addresses provided to the command and address terminals. When an active CS signal is provided to the memory device 200, the commands and addresses can be decoded, and memory operations can be performed. The command signals CMD may be provided as internal command signals ICMD to a command decoder 215 via the command/address input circuit 205.

The command decoder 215 may include circuits to decode the internal command signals ICMD to generate various internal signals and commands for performing memory operations, for example, a row command signal to select a word line and a column command signal to select a bit line. Other examples of memory operations that the memory device 200 may perform based on decoding the internal command signals ICMD includes a refresh command (e.g., re-establishing full charges stored in individual memory cells of the memory array 250), an activate command (e.g., activating a row in a particular bank, in some cases for subsequent access operations), or a precharge command (e.g., deactivating the activated row in the particular bank). The internal command signals can also include output and input activation commands, such as clocked command CMDCK (not shown).

The command decoder 215, in some embodiments, may further include one or more registers 228 for tracking various counts and/or values (e.g., counts of refresh commands received by the memory device 200 or self-refresh operations performed by the memory device 200) and/or for storing various operating conditions for the memory device 200 to perform certain functions, features, and modes (or test modes). As such, in some embodiments, the registers 228 (or a subset of the registers 228) may be referred to as mode registers. Additionally, or alternatively, the memory device 200 may include registers 228 as a separate component outside of the command decoder 215. In some embodiments, the registers 228 may include multi-purpose registers (MPRs) configured to write and/or read specialized data to and/or from the memory device 200.

When a read command is issued to a bank with an open row and a column address is timely supplied as part of the read command, read data can be read from memory cells in the memory array 250 designated by the row address (which may have been provided as part of the activate command identifying the open row) and column address. The read command may be received by the command decoder 215, which can provide internal commands to an input/output circuit 260 so that read data can be output from the data terminals DQ, RDQS, DBI, and DMI via read/write amplifiers 255 and the input/output circuit 260 according to the RDQS clock signals. The read data may be provided at a time defined by read latency information RL that can be programmed in the memory device 200, for example, in a mode register (e.g., one or more of the registers 228). The read latency information RL can be defined in terms of clock cycles of the CK clock signal. For example, the read latency information RL can be a number of clock cycles of the CK signal after the read command is received by the memory device 200 when the associated read data is provided.

When a write command is issued to a bank with an open row and a column address is timely supplied as part of the write command, write data can be supplied to the data terminals DQ, DBI, and DMI according to the WCK and WCKF clock signals. The write command may be received by the command decoder 215, which can provide internal commands to the input/output circuit 260 so that the write data can be received by data receivers in the input/output circuit 260, and supplied via the input/output circuit 260 and the read/write amplifiers 255 to the memory array 250. The write data may be written in the memory cell designated by the row address and the column address. The write data may be provided to the data terminals at a time that is defined by write latency WL information. The write latency WL information can be programmed in the memory device 200, for example, in a mode register (e.g., one or more of the registers 228). The write latency WL information can be defined in terms of clock cycles of the CK clock signal. For example, the write latency information WL can be a number of clock cycles of the CK signal after the write command is received by the memory device 200 when the associated write data is received.

The memory device 200 can include one or more reliability, availability, and serviceability (RAS) features, such as ECC components. For example, as shown in FIG. 2, the memory device 200 includes ECC circuitry 262. The ECC circuitry 262 can include die-level ECC components and/or device-level ECC components. The memory device 200 can include the ECC circuitry 262 in addition to or in lieu of a system-level ECC component (e.g., ECC circuitry in the host device 120 of FIG. 1 or at another location outside of the memory device 200). Although shown with the ECC circuitry 262 as a separate component outside of the input/output circuit 260 in FIG. 2, the memory device 200 may include the ECC circuitry 262 as part of the input/output circuit 260 in other embodiments.

The ECC circuitry 262 of FIG. 2 can include an ECC engine and/or can be configured to generate ECC information based at least in part on (a) data to be written to the memory array 250 of the memory device 200 and/or (b) data read from the memory array 250 of the memory device 200. The ECC information calculated by the ECC circuitry 262 can include parity bits or other data (e.g., single-bit error correction and double-bit error detection codes) that can be used to identify and/or correct errors (e.g., bit insertions, bit deletions, or a bit inversions/flips) in data written to or read from the memory array 250. In some embodiments, the ECC circuitry 262 calculates or generates ECC information when the memory device 200 receives data to be written to the memory array 250. The generated ECC information can be written to the memory array 250 (e.g., to a portion of the memory array 250 configured to store ECC information) in addition to the corresponding write data.

The ECC information can be used to identify and/or correct errors in data written to or read from the memory array 250. In particular, as a codeword (e.g., data and corresponding ECC information) is read from the memory array 250 during a read operation or during an ECS operation, the ECC circuitry 262 can (a) recalculate or regenerate the ECC information based on the data in the codeword and (b) compare the recalculated ECC information to the retrieved ECC information in the codeword. If the recalculated ECC information matches the retrieved ECC information, then the ECC circuitry 262 can determine that there are no errors present in the corresponding data read from the memory array 250. On the other hand, if the recalculated ECC information does not match the retrieved ECC information, the ECC circuitry 262 (i) can determine that at least one error is present in the corresponding data read from the memory array 250, and/or (ii) can use the recalculated ECC information and/or the retrieved ECC information to correct one or more of the errors in the data and/or determine the error type. For a read operation, the memory device 200 can thereafter output the corrected data to, for example, a host device (e.g., the host device 102 of FIG. 1). For an ECS operation, the memory device 200 can rewrite the corrected data to the memory array 250.

As discussed above, the memory array 250 may include a number of redundant memory rows (e.g., per memory bank or other memory region). The redundant memory rows can be used to perform repair operations on memory rows of the memory array 250 that include failing memory cells. In particular, a logical row address associated with a memory row of the memory array 250 including defective memory cells can be remapped to a redundant memory row of the memory array 250 as part of a PPR procedure. In some modes of operation, the repair operation may be a hard (or permanent) repair operation, in which the remapping of the logical address to the redundant memory row is stored in a non-volatile form (e.g., stored in a manner that is maintained even when the memory device 200 and/or a corresponding memory system is powered down). In other modes of operation, the repair operation may be a soft (or temporary) repair operation, in which (a) a set of volatile memory elements (such as latches, registers, and/or flip-flops) may be used to temporarily store updated addresses for a repair operation and (b) a decoder can map the defective addresses to another group of memory cells. The other group of memory cells can be a group of redundant memory cells (e.g., a row of redundant memory cells) that are dedicated to soft post package repair (sPPR).

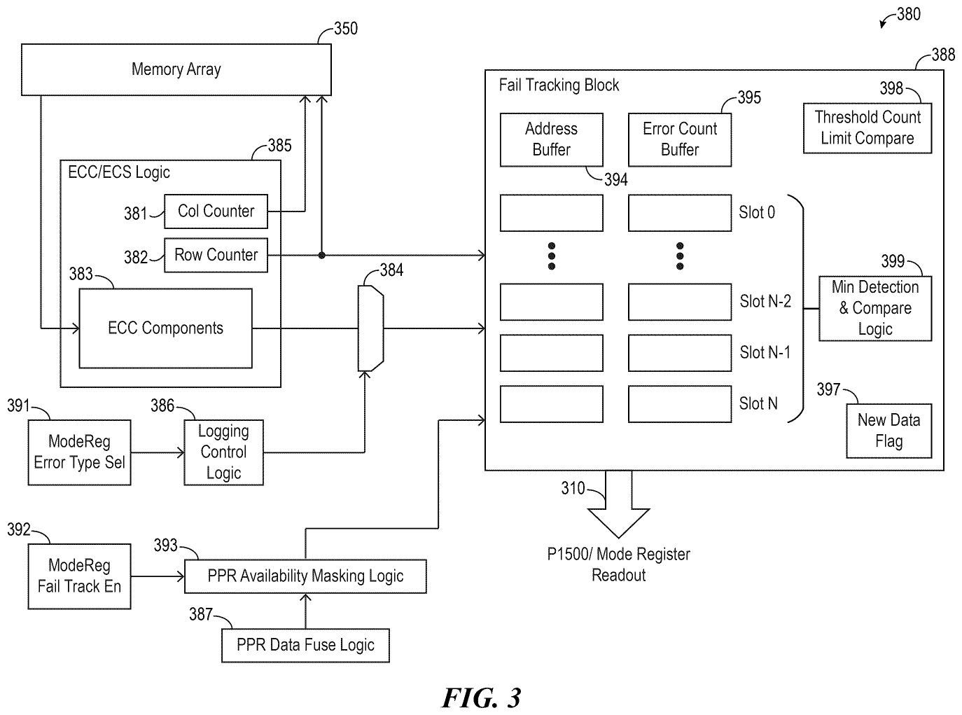

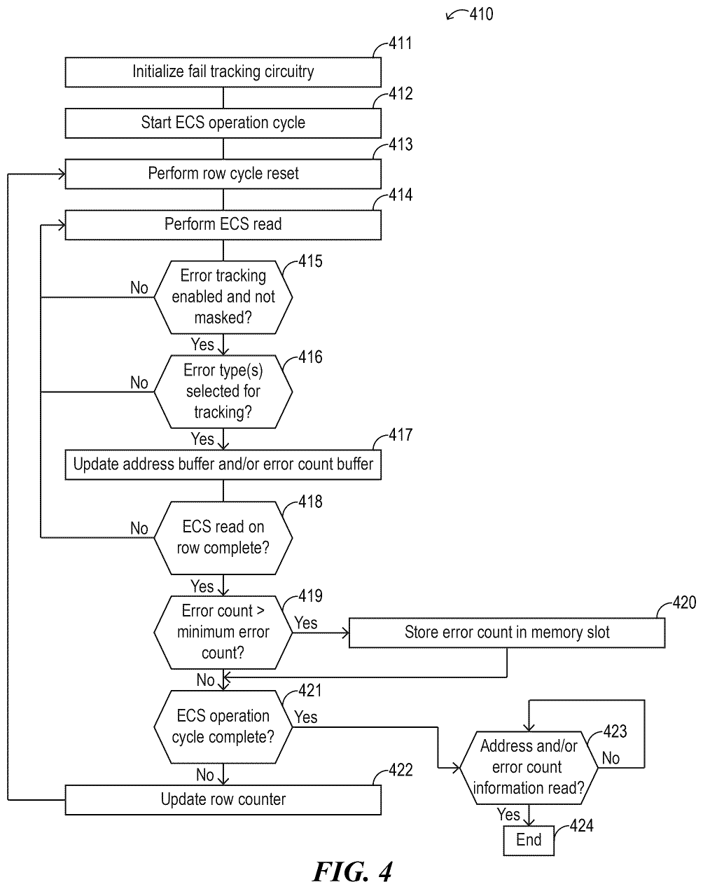

Redundant memory rows available for PPR operations are a limited resource. Therefore, the memory device 200 can include fail tracking circuitry (described in greater detail below with reference to FIGS. 3 and 4) that can track information useful for identifying the worst memory rows in (e.g., a memory bank or other memory region of) the memory array 250 that are optimal targets for PPR operations. For example, fail tracking circuitry configured in accordance with various embodiments of the present technology can be configured to track a plurality of addresses corresponding to memory rows exhibiting the greatest numbers of errors identified and/or corrected by the ECC circuitry 262 of FIG. 2. Additionally, or alternatively, the fail tracking circuitry can be configured to track addresses of memory rows exhibiting certain or select types of errors (e.g., uncorrectable errors, multi-bit correctable errors, single-bit correctable errors) identified and/or corrected by the ECC circuitry 262. In some embodiments, the fail tracking circuitry can be configured to track and store this information while the memory device 200 performs an ECS operation. In these and other embodiments, the fail tracking circuitry can be configured to track and store this information whenever the memory device 200 reads out data from the memory array 250, and/or during other operations of the memory device 200.

FIG. 3 is a schematic block diagram of fail tracking circuitry 380 configured in accordance with various embodiments of the present technology. As shown, the fail tracking circuitry 380 includes an ECC/ECS logic block 385, a fail tracking block 388, and a multiplexer 384. The fail tracking circuitry 380 further includes one or more error type selection mode registers 391, logging control logic 386, one or more fail tracking enable mode registers 392, PPR availability masking logic 393, and PPR data fuse logic 387.

Referring first to the ECC/ECS logic block 385, the ECC/ECS logic block 385 includes a column counter 381, a row counter 382, and ECC components 383 (e.g., an ECC engine, a syndrome generator, a syndrome decoder). Although not shown in FIG. 3, the ECC/ECS logic block 385 can also include a bank counter in some embodiments. In operation, the ECC/ECS logic block 385 is configured to read out data stored in a memory array 350, check the data for errors, and output a signal to the multiplexer 384 indicating (i) whether one or more errors were detected in the read data and/or (ii) the type(s) of error(s) detected. For example, during an ECS operation, a read operation, and/or another operation of the memory device, the ECC/ECS logic block 385 can read out data stored to addresses in the memory array 350 that are indicated by the column counter 381 and the row counter 382. As the data is read out from the memory array 350 into the ECC/ECS logic block 385, the ECC components 383 of the ECC/ECS logic block 385 can (a) check the data for errors, (b) attempt to correct any identified errors, and/or (c) determine the type(s) of any identified errors. Thereafter, the ECC/ECS logic block 385 can output to the multiplexer 384 indications of whether errors were detected in the data read from the memory array 350 and/or indications of the types of errors detected. For example, in embodiments in which three error types are possible, the ECC/ECS logic block 385 can output a two-bit signal to the multiplexer 384. As a specific example, the ECC/ECS logic block 385 can output a ‘00’ signal when the ECC components 383 do not detect any errors in the data read out from the memory array 350, a ‘01’ signal when the ECC components 383 detect a single-bit correctable error (CEs) in data read out from the memory array 350, a ‘10’ signal when the ECC components 383 detect a multi-bit correctable error (CEm) in data read out from the memory array 350, and/or a ‘11’ signal when the ECC components 383 detect an uncorrectable error (UE) in data read out from the memory array 350. Other signals and/or numbers of bits per signal output by the ECC/ECS logic block 385 (e.g., for each respective error type or to indicate that no errors were detected) are of course possible and are within the scope of the present technology. In some embodiments, the ECC/ECS logic block 385 can be configured such that it does not output a signal unless an error is detected in data read out from the memory array 350. Although not shown in FIG. 3, when data is read from the memory array 350 into the ECC/ECS logic block 385 during an ECS operation and errors in the data are identified and corrected by the ECC components 383, corrected data can be written back to the memory array 350 (e.g., at the address indicated by the column counter 381 and/or the row counter 382).

The error type selection mode register(s) 391 and the logging control logic 386 of the fail tracking circuitry 380 can be used to control the type(s) of errors tracked by the fail tracking block 388. For example, a user/operator and/or a host device can program the error type selection mode register(s) 391 to indicate which types of errors should be tracked/logged in the fail tracking block 388. For example, the error type selection mode register(s) 391 can be programmed to select any combination of possible error types to track in the fail tracking block 388. As specific examples, the error type selection mode register(s) 391 can be programmed to indicate that only uncorrectable errors should be tracked in the fail tracking block 388, only multi-bit correctable errors should be tracked in the fail tracking block 388, or only single-bit correctable errors should be tracked in the fail tracking block 388. As additional specific examples, the error type selection mode register(s) 391 can be programmed to indicate that only uncorrectable errors and multi-bit correctable errors (but not single-bit correctable errors) should be tracked in the fail tracking block 388, only uncorrectable errors and single-bit correctable errors (but not multi-bit correctable errors) should be tracked in the fail tracking block 388, or only multi-bit correctable errors and single-bit correctable errors (but not uncorrectable correctable errors) should be tracked in the fail tracking block 388. As still another specific example, the error type selection mode register(s) 391 can be programmed to indicate that uncorrectable errors, multi-bit correctable errors, and single-bit correctable errors should each be tracked in the fail tracking block 388. Thus, because different types of error can correspond to different error severities, a user/operator and/or a host device can use the error type selection mode register(s) 391 to specify one or more error severities to track/log in the fail tracking block 388.

The logging control logic 386 of FIG. 3 outputs a control signal to the multiplexer 384 that depends on programming of the error type selection mode register(s) 391. For example, if a user/operator and/or a host device programs the error type selection mode register(s) 391 to indicate that only uncorrectable errors and multi-bit correctable errors (but not single-bit correctable errors) should be tracked in the fail tracking block 388, the logging control logic 386 will output a corresponding control signal to the multiplexer 384 such that the multiplexer 384 passes only signals received from the ECC/ECS logic block 385 to the fail tracking block 388 that indicate that an uncorrectable error or a multi-bit correctable error has been detected in data read out from the memory array 350. Continuing with this example, signals output from the ECC/ECS logic block 385 to the multiplexer 384 that indicate that a single-bit correctable error has been detected in the data read out from the memory array 350 will not be passed through the multiplexer 384 to the fail tracking block 388. As such, in this example, the fail tracking block 388 will not track or log that a single-bit correctable error has been detected in the data read out from the memory array 350. In other words, the output of the multiplexer 384 can function as a clock signal for the fail tracking block 388, informing the fail tracking block 388 when to update an address buffer 394 and/or an error count buffer 395 of the fail tracking block 388.

The fail tracking enable mode register(s) 392 and the PPR availability masking logic 393 of the fail tracking block 388 can be used to generate an enable signal for the fail tracking block 388. More specifically, a user/operator and/or a host device can program the fail tracking enable mode register(s) 392 to selectively enable or disable the error tracking feature of the fail tracking block 388. For example, the one or more fail tracking enable mode register(s) 392 can be programmed to disable the error tracking feature of the fail tracking block 388 such that errors (e.g., regardless of type) identified by the ECC/ECS logic block 385 are not tracked or logged by the fail tracking block 388.

Assuming that the fail tracking enable mode register(s) 392 are programmed to enable the error tracking feature of the fail tracking circuitry 380, the PPR availability masking logic 393 can be used to mask (or disable) error tracking in memory regions in which redundant memory rows are not available to perform PPR operations. For example, the PPR data fuse logic 387 can track the number of redundant memory rows available for PPR operations for a given memory region (e.g., for a given memory bank, for a given memory bank group, for a given memory die). Continuing with this example, when the PPR data fuse logic 387 indicates that no redundant memory rows for a given memory region are available to replace defective memory rows in that memory region, the PPR availability masking logic 393 can mask tracking and/or logging of error counts in the fail tracking block 388 for that memory region (e.g., to conserve resources). In some embodiments, the PPR availability masking logic 393 can mask tracking and/or logging of error counts in the fail tracking block 388 by de-asserting the enable signal output from the PPR availability masking logic 393 to the fail tracking block 388.

Although not shown in FIG. 3, to identify a current memory region and/or to determine when to mask tracking and/or logging of error counts in the fail tracking block 388, the PPR availability masking logic 393 and/or the PPR data fuse logic 387 can be provided the row address indicated by the row counter 382, the column address indicated by the column counter 381, a bank address, and/or other address/chip select information corresponding to memory rows (or memory cells) in the memory array 350 that are being read out to the ECC/ECS logic block 385 from the memory array 350. In some embodiments, the PPR availability masking logic 393 and/or the PPR data fuse logic 387 can be omitted and/or overridden such that the fail tracking circuitry 380 continues to track and/or log error counts in the fail tracking block 388 even for memory regions in which no redundant memory rows are available for PPR operations. In these and other embodiments, the fail tracking enable mode register(s) 392 can be omitted, for example, such that the error tracking feature of the fail tracking block 388 is always enabled or is enabled until masked by the PPR availability masking logic 393.

Referring now to the fail tracking block 388, the fail tracking block 388 includes the address buffer 394, the error count buffer 395, a plurality of memory slots Slot 0-Slot N, minimum detection and compare logic 399, threshold count limit compare logic 398, and a new data flag 397. The address buffer 394 is configured to temporarily store address information (e.g., row address, bank address) that corresponds to a memory row in the memory array 350 from which data is currently being read into or by the ECC/ECS logic block 385. The error count buffer 395 (also sometimes referred to herein as an “error counter”) is configured to temporarily store an error count that corresponds to a number of errors (e.g., of the type specified in the type selection mode register(s) 391) identified by the ECC/ECS logic block 385 in data read from the memory row that corresponds to the address information stored to the address buffer 394. As discussed above, the address buffer 394 and/or the error count buffer 395 can be updated based at least in part on the output of the multiplexer 384. Additionally, or alternatively, the address buffer 394 and/or the error count buffer 395 can be reset each time the ECC/ECS logic block 385 reads data out from a different memory row of the memory array 350.

The plurality of memory slots Slot 0-Slot N are configured to store address information and error counts corresponding to memory rows in a given memory region (e.g., in the memory array 350, in a given memory bank, in a given memory bank group, in a given memory die). In some embodiments, the fail tracking block 388 can include a memory slot in the plurality of memory slots Slot 0-Slot N for every memory row in the memory region such that the fail tracking block 388 is configured to track and log error counts corresponding to every memory row in the memory region. In other embodiments, the fail tracking block 388 can include a number of memory slots (e.g., two memory slots, four memory slots, eight memory slots, ten memory slots, sixteen memory slots, thirty-two memory slots) in the plurality of memory slots Slot 0-Slot N that is less than the total number of memory rows in the memory region. As a specific example, the fail tracking block 388 can include a same number of memory slots in the plurality of memory slots Slot 0-Slot N as there are redundant memory rows designated to the given memory region.

In embodiments in which the fail tracking block 388 includes a number of memory slots in the plurality of memory slots Slot 0-Slot N that is less than the total number of memory rows in the memory region, the fail tracking block 388 can be configured to store address information and error counts corresponding to the worst memory rows in the memory region (e.g., memory rows in the memory region that exhibit the greatest risk of corrupting data, memory rows in the memory region that exhibit the greatest numbers of errors, and/or memory rows in the memory region that exhibit the greatest number of errors of the error type(s) specified in the type selection mode register(s) 391). For example, when address information corresponding to a memory row in the memory array 350 is stored to the address buffer 394 and an error count corresponding to that memory row is stored to the error count buffer 395, the minimum detection compare logic 399 can compare the error count in the error count buffer 395 to a minimum error count currently stored in the plurality of memory slots Slot 0-Slot N. In the event that the error count in the error count buffer 395 is greater than the minimum error count in the plurality of memory slots Slot 0-Slot N, the minimum detection compare logic 399 can (a) replace the minimum error count in the plurality of memory slots Slot 0-Slot N with the error count in the error count buffer 395 and (b) replace address information in the plurality of memory slots Slot 0-Slot N that corresponds to the minimum error count with the address information in the address buffer 394. On the other hand, in the event that the error count in the error count buffer 395 is not greater than the minimum error count in the memory slot, the address information in the address buffer 394 and the error count in the error count buffer 395 can be discarded (without being stored to a memory slot in the plurality of memory slots Slot 0-Slot N) when the address buffer 394 and the error count buffer 395 are reset.

As shown in FIG. 3, address information and/or error counts that are stored to the plurality of memory slots Slot 0-Slot N can be read out to a user/operator and/or a host device via an output 310 of the fail tracking block 388 (e.g., via a P1500 interface, via a mode register readout, and/or via another readout mechanism). In some embodiments, the fail tracking block 388 can be configured to output all or a subset of the information stored to the plurality of memory slots Slot 0-Slot N. For example, the fail tracking block 388 can be configured to output only address information (and not the corresponding error counts). As another example, the fail tracking block 388 can be configured to output a preset number of the memory slots (e.g., address information and/or corresponding error counts of only the five worst memory rows in a given memory region). As still another example, the fail tracking block 388 can be configured to (e.g., serially) read out all of the address information and/or the corresponding error counts from the plurality of memory slots Slot 0-Slot N. It is expected that such information read out from the fail tracking block 388 will be useful in various operations of the corresponding memory device and/or memory system. For example, it is expected that the address information and corresponding error counts will be useful in identifying (e.g., a plurality of) memory rows in a given memory region that pose a high risk of data corruption and/or that are optimal targets for PPR operations.

After new address and/or error count information is stored to the plurality of memory slots Slot 0-Slot N, the new data flag 397 can be set to indicate that the fail tracking block 388 includes address and/or error count information that has not previously been read out of the fail tracking block 388. The new data flag 397 can help ensure that the new address and/or error count information is not overwritten (e.g., by a subsequently scheduled or routine ECS operation). In some embodiments, the new data flag 397 can include a stored value (e.g., a bit value). The new data flag 397 can be reset (or otherwise initialized) when (a) the new address and/or error count information is read out from the fail tracking block 388 and/or (b) the fail tracking circuitry 380 is initialized.

The threshold count limit compare logic 398 of the fail tracking block 388 can be configured to limit information stored to the plurality of memory slots Slot 0-Slot N and/or output from the fail tracking block 388. For example, the threshold count limit compare logic 398 can be configured to compare error counts stored in the error count buffer 395 to a predetermined, preset, and/or preselected minimum error count threshold. When an error count stored in the error count buffer 395 is less than the minimum error count threshold, the threshold count limit compare logic 398 can prevent the error count and the corresponding address information in the address buffer 394 from being stored in a memory slot of the plurality of memory slots Slot 0-Slot N (e.g., even if the error count in the error count buffer 395 is greater than a minimum error count currently stored in the plurality of memory slots Slot 0-Slot N.). Additionally, or alternatively, the threshold count limit compare logic 398 can be configured to compare error counts stored in memory slots of the plurality of memory slots Slot 0-Slot N to a predetermined, preset, and/or preselected minimum error count threshold such that (a) only error counts that meet or exceed the minimum error count threshold (and corresponding address information) are output from the fail tracking block 388 to a user/operator and/or a host device, and/or (b) error counts (and corresponding address information) stored to the memory slots are only output from the fail tracking block 388 when at least one error count in the memory slots meet or exceeds the minimum error count threshold. In other embodiments, the threshold count limit compare logic 398 can be omitted or disabled.

In some embodiments, the fail tracking circuitry 380 can be global fail tracking circuitry that is configured to track and/or store error counts corresponding to memory rows across the entire memory array 350. In other embodiments, the fail tracking circuitry 380 can be fail tracking circuitry that is configured to track and/or store error counts corresponding to memory rows in a memory region (e.g., in one or more memory banks, in one or more memory bank groups, in one or more memory dies) representing less than the entire memory array 350. In such embodiments, a memory device can include several instances of the fail tracking circuitry 380 (e.g., with each instance corresponding to a different memory region in the memory array 350).

FIG. 4 is a flow diagram illustrating a method 410 of tracking errors in data stored to a memory array, in accordance with various embodiments of the present technology. The method 410 is illustrated as a set of steps or blocks 411-424. All or a subset of one or more of the blocks 411-424 can be executed by components of a memory system and/or a memory device, such as components of the SiP device 100 of FIG. 1, the HBM device 130 of FIG. 1, and/or the memory device 200 of FIG. 2. For example, all or a subset of one or more of the blocks 411-424 can be executed by fail tracking circuitry, ECC circuitry, and/or a memory array. Furthermore, all or a subset of one or more of the blocks 411-424 can be executed by a user or operator and/or by a host device (e.g., the host device 102 of FIG. 2). Moreover, any one or more of the blocks 411-424 can be executed in accordance with the discussion of FIGS. 1-3 above.

The method 410 begins at block 411 by initializing fail tracking circuitry of a memory device. In some embodiments, initializing the fail tracking circuitry can include resetting or otherwise initializing a column counter, a row counter, and/or a bank counter of the fail tracking circuitry. In these and other embodiments, initializing the fail tracking circuitry can include resetting or otherwise initializing an address buffer and/or an error count buffer of the fail tracking circuitry. In these and still other embodiments, initializing the fail tracking circuitry can include resetting or otherwise initializing a new data flag.

In some embodiments, initializing the fail tracking circuitry can include initializing the fail tracking circuitry in response to an internal command (e.g., from a corresponding memory device) and/or an external command (e.g., received from a host device or a user/operator). In these and other embodiments, initializing the fail tracking circuitry can include initializing the fail tracking circuitry in anticipation of the corresponding memory device executing a specific operation (e.g., an ECS operation, a read operation, an access operation). For the sake of clarity and example, the remainder of the method 410 will be discussed in detail below in the context of the memory device executing an ECS operation.

At block 412, the method 410 continues by starting an ECS operation cycle. In some embodiments, starting an ECS operation cycle can include resetting or otherwise initializing the row counter and/or the bank counter of the fail tracking circuitry.

At block 413, the method 410 continues by performing a row cycle reset. In some embodiments, performing a row cycle reset includes resetting or otherwise initializing the column counter of the fail tracking circuitry. In these and other embodiments, performing the row cycle reset includes resetting or otherwise initializing the address buffer and/or the error count buffer of the fail tracking block of the fail tracking circuitry.

At block 414, the method 410 continues by performing an ECS read. Performing an ECS read can include reading data out from a memory array and into an ECC/ECS logic block of the fail tracking circuitry, checking the data for errors, correcting identified errors, outputting an indication of whether errors were identified in the data, and/or writing corrected data back to the memory array. In some embodiments, reading out the data includes reading out a codeword or other data stored to a memory location in the memory array that corresponds to a row address indicated by the row counter (e.g., for a given memory bank or other given memory region). Reading out the data can additionally, or alternatively, include reading out a codeword or other data stored to a memory location in the memory array that corresponds to a column address indicated by the column counter. In these and other embodiments, checking the data for errors can include checking the data for errors using ECC components and/or circuitry. For example, checking the data for errors can include checking a syndrome corresponding to the data read out from the memory array.

In the event errors are detected in the data, an indication that errors were identified in the data and/or an indication of the type(s) of errors (e.g., uncorrectable, multi-bit correctable, single-bit correctable) identified can be output. In the event errors are not detected in the data, an indication that no errors were identified in the data can be output or no signal can be output. Writing corrected data back to the memory array can include writing data devoid of the identified errors back to the memory location in the memory array indicated by the row counter and the column counter. In some embodiments, performing the ECS read can additionally include incrementing the column counter after determining that no errors were identified in the data read from the memory array and/or after writing corrected data back to the memory array.

At block 415, the method 410 continues by determining whether the error tracking feature of the fail tracking circuitry is enabled and not masked. Determining whether the error tracking feature of the fail tracking circuitry is enabled can include reading information programmed to fail tracking enable mode register(s) of the fail tracking circuitry. In these and other embodiments, determining whether the error tracking feature of the fail tracking circuitry is not masked can include determining whether there are one or more redundant memory rows available for performing a PPR operation. Determining whether there are one or more redundant memory rows can include tracking use of redundant memory rows, such as using PPR data fuse logic of the fail tracking circuitry. In these and still other embodiments, determining whether the error tracking feature is enabled and not masked can include receiving an asserted enable signal (e.g., at a fail tracking block of the fail tracking circuitry). The enable signal can be based at least in part on information programmed to the fail tracking enable mode register(s), an output of the PPR data fuse logic, and/or an output of PPR availability masking logic of the fail tracking circuitry. In the event the method 410 determines that the error tracking feature is enabled and not masked (block 415: Yes), the method 410 can proceed to block 416. On the other hand, in the event the error tracking feature is disabled and/or is masked (block 415: No), the method 410 can return to block 414 to perform a next ECS read of the ECS operation.

At block 416, the method 410 continues by determining whether one or more types of the errors identified in data read from the memory array at block 414 are selected for tracking by the fail tracking circuitry. In some embodiments, determining whether the type(s) of the errors identified in data read from the memory array are selected for tracking includes reading data programmed to error type selection mode register(s) of the fail tracking circuitry. In these and other embodiments, determining whether the type(s) of the errors identified in data read from the memory array are selected for tracking includes outputting, from logging control logic of the fail tracking circuitry, a control signal to a multiplexer of the fail tracking circuitry. The control signal can be based at least in part on the information programmed to the error type selection mode register(s). In these and still other embodiments, determining whether the type(s) of the errors identified in data read from the memory array are selected for tracking includes selectively passing, based at least on the control signal, indications of the type(s) of errors output from the ECC/ECS logic block through the multiplexer and to the fail tracking block of the fail tracking circuitry. In some embodiments, determining whether the type(s) of the errors identified in data read from the memory array are selected for tracking includes receiving a clock signal at the fail tracking block indicating when the fail tracking block should update an address buffer and/or an error count buffer of the fail tracking block. In the event that the method 410 determines that the type(s) of the errors identified in the data read from the memory array are selected for tracking by the fail tracking circuitry (block 416: Yes), the method 410 can proceed to block 417. On the other hand, in the event that the method 410 determines that the type(s) of the errors identified in the data read from memory array are not selected for tracking (or are masked off from tracking) by the fail tracking circuitry (block 416: No), the method 410 can return to block 414 to perform a next ECS read of the ECS operation.

At block 417, the method 410 continues by updating the address buffer and/or the error count buffer of the fail tracking block of the fail tracking circuitry. In some embodiments, updating the address buffer can include updating the address buffer to store address information (e.g., memory row address, memory bank) corresponding to the memory row in the memory array from which data was read out into the ECC/ECS logic block 385 at block 414. In these and other embodiments, updating the error count buffer can include incrementing a current value stored to the error count buffer (e.g., by one or another value). In other embodiments, only the error count buffer is updated at block 417, and the address buffer can be updated when the row counter is updated.

At block 418, the method 410 continues by determining whether the ECS read has been performed on the entire memory row. In some embodiments, determining whether the ECS read has been performed on the entire memory row includes determining whether data has been read out of all columns of the memory row (e.g., that are subject to the ECS operation) into the ECC/ECS logic block 385. In some embodiments, determining whether data has been read out of all columns of the memory row includes comparing a current value of the column counter to a threshold. In the event that the method 410 determines that data has been read out of all columns of the memory row (block 418: Yes), the method 410 can proceed to block 419. On the other hand, in the event that the method 410 determines that data has not been read out of all columns of the memory row (block 418: No), the method 410 can return to block 414 to perform a next ECS read of the ECS operation. In some embodiments, the method 410 can increment the column counter before returning to block 414.

At block 419, the method 410 continues by determining whether the error count stored in the error count buffer is greater than a minimum error count stored in the memory slots of the fail tracking block. In some embodiments, determining whether the error count stored in the error count buffer is greater than the minimum error count can include (a) identifying the minimum error count stored in the memory slots of the fail tracking block, and (b) comparing the error count stored in the error count buffer to the minimum error count. In some embodiments, an empty or open memory slot in the fail tracking block can be considered as currently storing the minimum error count or an error count equal to zero. In the event that the method 410 determines that the error count stored in the error count buffer is greater than the minimum error count (block 419: Yes), the method 410 can proceed to block 420. On the other hand, in the event that the method 410 determines that the error count stored in the error count buffer is not greater than the minimum error count (block 419: No), the method 410 can proceed to block 421.

At block 420, the method 410 continues by storing the error count in the error count buffer and the corresponding address information in the address buffer to a memory slot of the fail tracking block. In some embodiments, storing the error count in the error count buffer to the memory slot can include replacing (e.g., by erasing and/or overwriting) the minimum error count stored to the memory slot with the error count in the error count buffer. In these and other embodiments, storing the corresponding address information in the address buffer to the memory slot can include replacing (e.g., by erasing and/or overwriting) address information corresponding to the minimum error count with the address information in the address buffer. In these and still other embodiments, storing the error count in the error count buffer and the address information in the address buffer to the memory slot can include identifying a new minimum error count of the error counts stored in the memory slots of the fail tracking block (including the error count newly written to the memory slot from the error count buffer). After identifying the new minimum error count, the method 410 can proceed to block 421. In other embodiments, the new minimum error count can be identified at another timing (e.g., at a timing corresponding to when a new error count is stored to the error count buffer).

At block 421, the method 410 continues by determining whether the ECS operation cycle is complete. In some embodiments, determining whether the ECS operation cycle is complete can include comparing the current value indicated by the row counter to a threshold. In the event that the method 410 determines that the ECS operation is not complete (block 421: No), the method 410 can proceed to block 422. On the other hand, in the event that the method 410 determines that the ECS operation is complete (block 421: Yes), the method 410 (a) can set the new data flag to a value that indicates that there is address information and/or corresponding error counts currently stored to memory slots of the fail tracking block of the fail tracking circuitry that have not previously been read out of the fail tracking block and (b) can proceed to block 423.

At block 422, the method 410 continues by updating the row counter. Updating the row counter can include incrementing the row counter and/or a bank counter (e.g., by one or another value). After updating the row counter, the method 410 can return to block 413 (e.g., to reset or otherwise initialize the address buffer, the error count buffer, and/or the column counter).

At block 423, the method 410 determines whether address information and/or corresponding error counts currently stored to memory slots of the fail tracking block have previously been read out of the fail tracking block. In some embodiments, determining whether the address information and/or corresponding error counts currently stored to the memory slots have previously been read includes determining whether the new data flag has been reset or set to another value that indicates that the address information and/or corresponding error counts currently stored to the memory slots have previously been read. For example, the method 410 can reset the new data flag or set the new data flag to another value when the address information and/or corresponding error counts are output from the fail tracking block. In the event that the method 410 determines that the address information and/or the corresponding error counts currently stored to the memory slots have not previously been read (block 423: No), the method 410 return to block 423. On the other hand, in the event that the method 410 determines that the address information and/or corresponding error counts currently stored to the memory slots have previously been read (block 423: Yes), the method 410 can proceed to block 424 to terminate.

Although the blocks 411-424 of the method 410 are discussed and illustrated in a particular order, the method 410 illustrated in FIG. 4 is not so limited. In other embodiments, the method 410 can be performed in a different order. In these and other embodiments, any of the blocks 411-424 of the method 410 can be performed before, during, and/or after any of the other blocks 411-424 of the method 410. Moreover, a person of ordinary skill in the relevant art will recognize that the illustrated method 410 can be altered and still remain within these and other embodiments of the present technology. For example, one or more blocks 411-424 of the method 410 (e.g., blocks 415, 416, and/or 423) illustrated in FIG. 4 can be omitted and/or repeated in some embodiments. As another example, all or a subset of one or more of the blocks 411-424 can be executed during other operations of a memory device (e.g., a read operation) in addition to or in lieu of an ECS operation.

### CONCLUSION

From the foregoing, it will be appreciated that specific embodiments of the technology have been described herein for purposes of illustration, but well-known structures and functions have not been shown or described in detail to avoid unnecessarily obscuring the description of the embodiments of the technology. To the extent any material incorporated herein by reference conflicts with the present disclosure, the present disclosure controls. Where the context permits, singular or plural terms may also include the plural or singular term, respectively. Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Furthermore, as used herein, the phrase “and/or” as in “A and/or B” refers to A alone, B alone, and both A and B. Additionally, the terms “comprising,” “including,” “having,” and “with” are used throughout to mean including at least the recited feature(s) such that any greater number of the same features and/or additional types of other features are not precluded. Further, the terms “approximately” and “about” are used herein to mean within at least within 10% of a given value or limit. Purely by way of example, an approximate ratio means within 10% of the given ratio.

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

From the foregoing, it will also be appreciated that various modifications may be made without deviating from the disclosure or the technology. For example, one of ordinary skill in the art will understand that various components of the technology can be further divided into subcomponents, or that various components and functions of the technology may be combined and integrated. In addition, certain aspects of the technology described in the context of particular embodiments may also be combined or eliminated in other embodiments.

Furthermore, although advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

We claim:

1. A memory device, comprising:
a memory array including a plurality of memory regions; and
fail tracking circuitry including a counter and a plurality of memory slots, wherein the fail tracking circuitry is configured, during an error check and scrub (ECS) operation, to:
for each memory row of a plurality of memory rows in a memory region—
count, using the counter, errors detected in data read from the memory row to determine an error count for the memory row; and
store the error count and address information for the memory row in a memory slot of the plurality of memory slots.

2. The memory device of claim 1, wherein the fail tracking circuitry is further configured, during the ECS operation, to:
for each memory row of the plurality of memory rows—
after determining the error count for the memory row, compare the error count to a minimum error count of all error counts currently stored to the plurality of memory slots; and
before storing the error count and the address information for the memory row in the memory slot, determine that the error count is greater than the minimum error count.

3. The memory device of claim 2, wherein, to store the error count and the address information for the memory row in the memory slot, the fail tracking circuitry is configured to replace the minimum error count and corresponding address information stored to one memory slot of the plurality of memory slots with the error count and the address information for the memory row.

4. The memory device of claim 1, wherein the plurality of memory rows is a first plurality of memory rows, and wherein the fail tracking circuitry is further configured, during the ECS operation, to:
for each memory row of a second plurality of memory rows in the memory region—
count, using the counter, errors detected in data read out from the memory row to determine an error count for the memory row;
compare the error count to a minimum error count of all error counts currently stored to the plurality of memory slots;
determine that the error count is less than the minimum error count; and
discard the error count without storing the error count or address information for the memory row in the plurality of memory slots.

5. The memory device of claim 1, wherein the fail tracking circuitry is further configured to:
receive a signal indicating one or more error types selected for counting; and
during the ECS operation, mask counting of errors detected in data read out from the memory region that correspond to error types not included in the one or more error types such that the error count determined for each memory row of the plurality of memory rows only represents a number of errors that correspond to the one or more error types selected for counting.

6. The memory device of claim 1, wherein the memory array includes a plurality of redundant memory rows per memory region, and wherein the fail tracking circuitry is further configured, during the ECS operation, to mask counting of errors detected in memory rows of the memory region when a number of the redundant memory rows for the memory region that are available for post-package repair (PPR) operations is zero.

7. The memory device of claim 1, wherein the fail tracking circuitry is further configured to output address information stored to the plurality of memory slots.

8. A method, comprising:
during an error check and scrub (ECS) operation of a memory device including a memory array—
counting a first number of errors detected in data read from a first memory row of the memory array;
storing the first number of errors and first address information corresponding to the first memory row for later readout;
counting a second number of errors detected in data read from a second memory row of the memory array; and
storing the second number of errors and second address information corresponding to the second memory row for later readout.

9. The method of claim 8, further comprising, during the ECS operation and before storing the first number of errors and the first address information—
compare the first number of errors to a third number of errors detected in data read from a third memory row of the memory array; and
determine that the first number of errors is greater than the third number of errors.

10. The method of claim 9, wherein storing the first number of error and the first address information includes replacing the third number of errors and third address information corresponding to the third memory row by overwriting the third number of errors and the third address information with the first number of errors and the first address information.

11. The method of claim 8, further comprising, during the ECS operation, identifying a lesser of the first number of errors and the second number of errors as a minimum number of errors.

12. The method of claim 11, further comprising:
during the ECS operation—
count a third number of errors detected in data read from a third memory row of the memory array;
compare third number of errors to the minimum number of errors;
determine that the third number of errors is less than the minimum number of errors; and
discard the third number of errors without storing the third number of errors for later readout.

13. The method of claim 8, wherein the memory array includes a plurality of redundant memory rows, and wherein the method further comprises tracking a number of redundant memory rows of the plurality of redundant memory rows that are available for post-package repair (PPR) operations.

14. The method of claim 13, further comprising masking counting of errors detected in data read from at least one memory row of the memory array when the number of redundant memory rows of the plurality of redundant memory rows that are available for PPR operations is zero.

15. The method of claim 8, further comprising:
receiving an indication of one or more error types selected for counting; and
based at least in part on the indication, masking counting of errors not of the one or more error types such that the first number of errors and the second number of errors each only represent errors that correspond to the one or more error types selected for counting.

16. Fail tracking circuitry, comprising:
a counter configured, during an error check and scrub (ECS) operation, to:
for each memory row of a plurality of memory rows, count errors detected in data read out from the memory row; and
a plurality of memory slots configured to store error counts and address information corresponding to respective memory rows of the plurality of memory rows for readout occurring after the ECS operation is complete.

17. The fail tracking circuitry of claim 16, further comprising logic configured to:
identify a minimum error count of the error counts stored to the plurality of memory slots;
compare an error count corresponding to a memory row of the plurality of memory rows to the minimum error count;
determine that the error count corresponding to the memory row is greater than the minimum error count; and
replace the minimum error count with the error count corresponding to the memory row by overwriting the minimum error count stored to the plurality of memory slots with the error count corresponding to the memory row.

18. The fail tracking circuitry of claim 16, further comprising logic configured to:
identify a minimum error count of the error counts stored to the plurality of memory slots;
compare an error count corresponding to a memory row of the plurality of memory rows to the minimum error count;
determine that the error count corresponding to the memory row is less than the minimum error count; and
discard the error count corresponding to the memory row such that the error count corresponding to the memory row is not stored for the readout occurring after the ECS operation is complete.

19. The fail tracking circuitry of claim 16, further comprising logic configured to mask errors corresponding to an error type not selected for counting from being counted by the counter.

20. The fail tracking circuitry of claim 16, further comprising logic configured to mask errors in data read out from memory rows from being counted by the counter when no redundant memory rows are available for post-package repair (PPR) operations for the memory rows.
